(19) United States
(12) Patent Application Publication
(10) Pub. No.: US 2007/0234521 A1
(43) Pub. Date: Oct. 11, 2007

(54) Double-axis hinge for use in electronic devices

(75) Inventor: Kimmo Komppa, Salo (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/400,346

(22) Filed: Apr. 6, 2006

(51) Int. Cl. E05D 3/06

(52) U.S. Cl. 16/366

(57) ABSTRACT

A hinge has two hinge arms for rotatably mounting a lower part of an electronic device of a clamshell design at a first rotational axis and for rotatably mounting an upper part of the electronic device at a second rotational axis. When the angle between the lower and second parts is within a first angular range, the hinge arms are rotated against the lower part in order to change the angle and the hinge leverage point is located substantially below the first rotational axis. When the angle is in a second angular range beyond the first angular range, the hinge arms are rotated against the upper part in order to change the angle and to move the leverage point away from the lower part. As such, the stability of the electronic device when the angle is in the second angular range.

### FIELD OF THE INVENTION

The present invention relates generally to a foldable electronic device which can be opened to reveal two facing surfaces of two device parts and, more particularly, to a hinge for linking the device parts.

### BACKGROUND OF THE INVENTION

Foldable electronic devices such as mobile phones, laptop computers, and PDAs comprise two device parts linked by a hinge. The hinge can be a single-axis construction wherein two hinge plates with coupling channels are separately connected to the device parts and a pin is inserted through the coupling channels as a pivot axis to join the two hinge plates. A single-axis hinge can also be constructed with a coil spring wrapped around a pivot pin wherein each end of the coil spring is secured to one device part.

Using a laptop computer as an example, the upper device part is the lid containing a display and the lower device part is the engine part containing the motherboard and the keyboard. When the laptop computer is placed on a flat surface in an open position and the angle between the lid and the engine part is large, say between 120 degrees and 180 degrees, the laptop computer may rock if the lid is heavy as compared to the engine part. In this case, the leverage point of the center of gravity of the lid in relation to the center of gravity of the engine part is located at the hinge. As the display is made larger, the lid becomes heavier and the laptop computer in such an open position becomes less stable.

It is advantageous and desirable to provide a hinge for use in an electronic device for reducing the “rocking” situation, thereby making the device more stable.

### SUMMARY OF THE INVENTION

The first aspect of the present invention is a method of improving the stability of a device of a clamshell type design in that the device has an upper part pivotably connected to a lower part via a hinge. The stability can be improved by moving the hinge leverage point away from the lower part when the device is open such that the angle between the upper part and the lower part is larger than 90 degrees.

The second aspect of the present invention is a hinge having two hinge arms for mounting a shaft linking the upper part to the lower part of an electronic device, wherein each of the hinge arms has a different pivot point for rotatably mounting the upper part so as to allow the hinge leverage point to be moved away from the center of gravity of the lower part.

The third aspect of the invention is an electronic device having such a hinge for opening and closing.

The hinge, according to the present invention, has two hinge arms, each hinge arm having a first section and a second section. The first section of each hinge arm is pivotably connected to a first bracket. Two first brackets are used to fixedly mount the upper part of the device so as to allow the upper part to rotate relative to the hinge arms about a first rotation axis. The hinge has a shaft connected to the second section of each hinge arm to define a second rotation axis of the hinge.

When the device is in a closed position and placed on a surface, the longitudinal axis of each hinge arm is substantially perpendicular to the surface. However, the angle between the longitudinal axis and the surface can be larger or smaller than 90 degrees. At this position, the hinge leverage point is located near the shaft. When a user opens the device, the upper part, along with the hinge arms, is rotated away from the lower part about the second rotation axis until the rotation angle substantially reaches an angle P, for example. When the rotation angle reaches the angle P, the first section of the hinge arms is in contact with the surface. At this position, the angle between the upper part and the lower part is equal to the angle P. The angle P can be equal to 105 degrees, for example. However, the angle P can be larger or smaller than 105 degrees or smaller than 90 degrees.

If the user opens the device further so that the angle between the upper part and the lower part is larger than the angle P, the user rotates the upper part against the hinge arms along the first rotation axis. As such, the user can adjust the angle between the upper part and the lower part until the upper part is in contact with the surface while keeping the hinge arms substantially stationary relative to the lower part. The upper part can be rotated against the hinge arms along the first rotation axis within an angle Q. The sum of the angles P and Q can be 180 degrees, for example.

Using a hinge with two independent rotational axes for rotating the upper device part in relation to the lower device part, the present invention effectively moves the leverage point on the hinge away from the center of gravity of lower part of the device. Because the distance between the center of gravity of the lower part and the leverage point increases, the device is more stable regarding the countering of the center of gravity of the lower part of the device against the center of gravity of the upper part.

When the user closes the device, the upper part is rotated against the hinge arms about the first rotation axis until the angle between the upper part and the lower part is equal to the angle P. If the user closes the device further, the upper part, along with the hinge arms, is rotated against the lower part about the second rotation axis.

In the above-described embodiment, when the device is in a closed position and a user opens the device, the upper part is stationary relative to the hinge arms until the longitudinal axis is substantially parallel to the lower part. Thus, the angle between the upper part and hinge arms remains the same while the hinge arms are rotated against the lower part about the second rotation axis. In a different embodiment, the angle between the upper part and the hinge arms is increased as the hinge arms are rotated against the lower part. Thus, both the first and second rotational axes are used when the user opens the device.

The present invention will become apparent upon reading the description taken in conjunction with FIGS. 1 to 4j.

### BRIEF DESCRIPTION OF THE DRAWINGS

FIG. 1 illustrates the hinge, according to present invention, having a shaft, wherein the primary leverage point is located near the rotation axis of the shaft.

FIG. 2 illustrates how the leverage point is moved away from the rotation axis of the shaft.

FIG. 3 illustrates the adjustment zone of the hinge.

FIGS. 4a to 4j illustrate an electronic device having an upper part rotatably linked to a lower part for opening and closing, in which:

FIG. 4a shows the device in a closed position;

FIG. 4b shows the upper part is rotated about the shaft against the lower part to open the device, wherein the angle between the upper part and the lower part is smaller than the angle P.

FIG. 4c shows the opening of the device wherein the angle between the upper part and the lower part is substantially equal to the angle P.

FIG. 4d shows the opening of the device with the upper part being rotated about the pivot point on the upper section of the hinge arms.

FIG. 4e shows the opening of the device wherein the angle between the upper part and the lower part is substantially equal to 180 degrees.

FIG. 4f shows the adjustment of the position of the upper part while the hinge arms are kept stationary relative to the lower part.

FIG. 4g shows the angle between the upper part and the lower part being narrowed further while the hinge arms are kept stationary relative to the lower part.

FIG. 4h shows the closing of the device with the upper part being rotated about the shaft against the lower part.

FIG. 4i illustrates another embodiment of the present invention wherein the upper part of the device is rotated against the lower part about two pivot points.

FIG. 4j illustrates the shifting of the leverage point as the upper part is further rotated against the lower part.

### DETAILED DESCRIPTION OF THE INVENTION

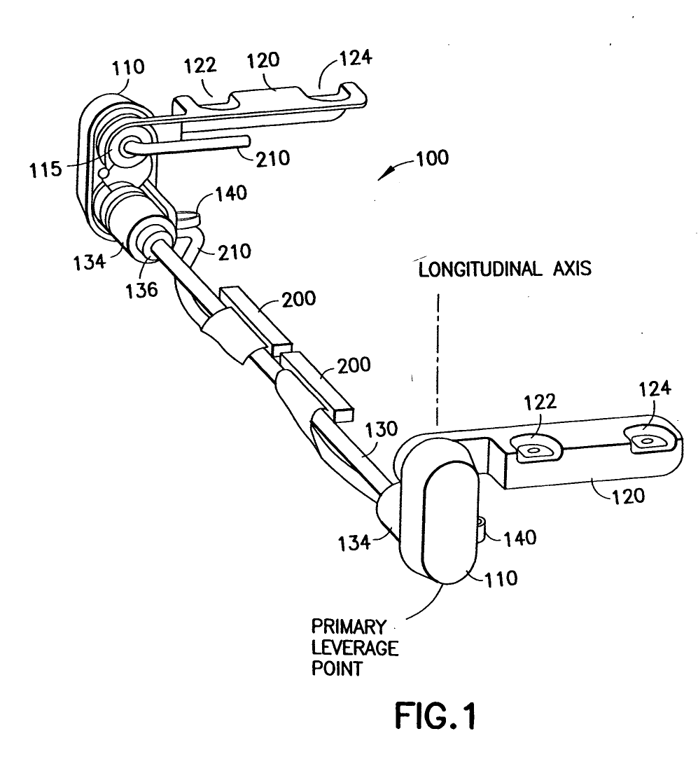

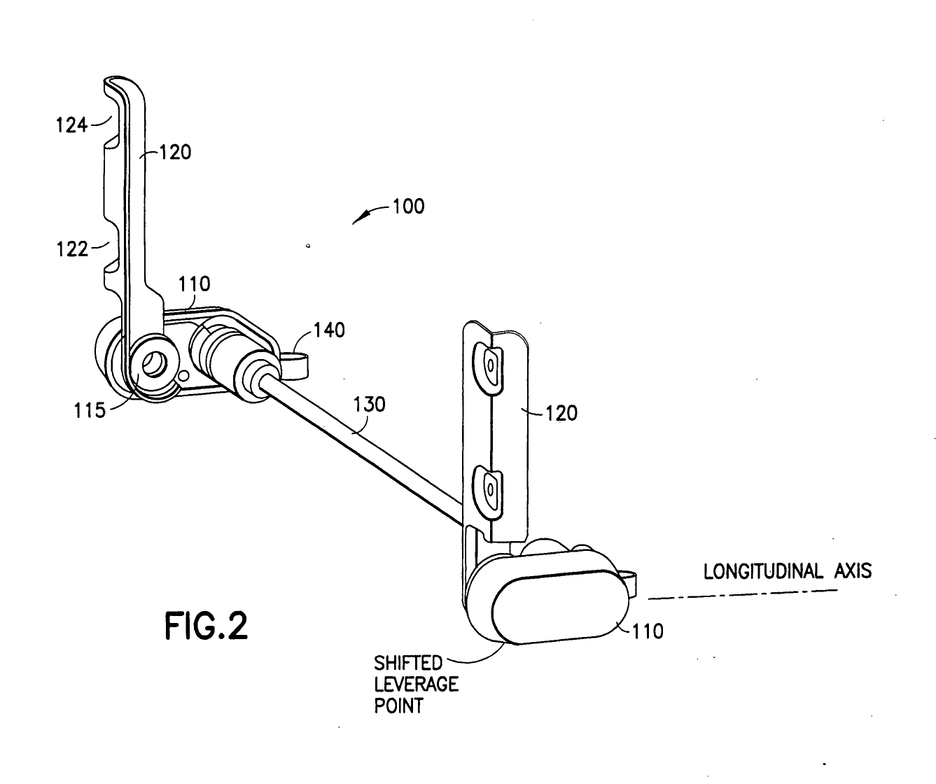

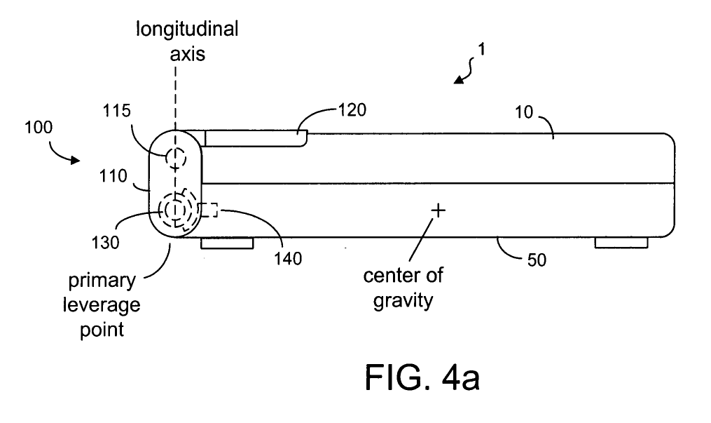

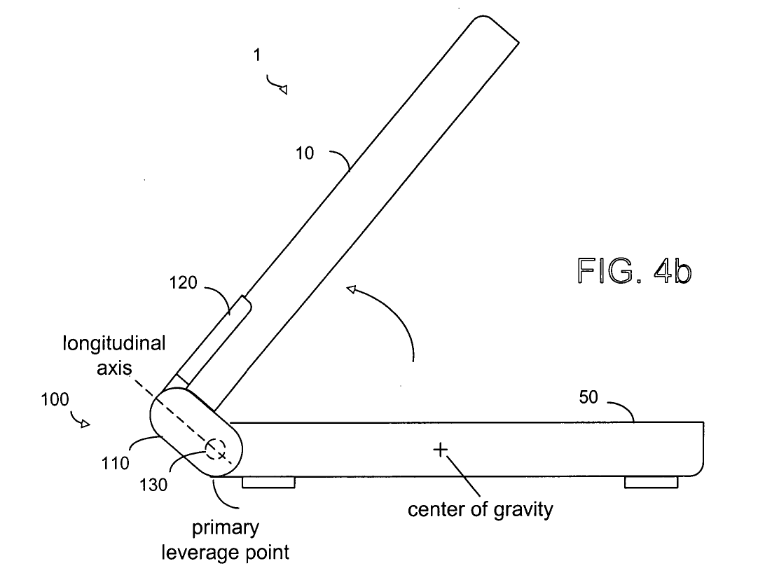

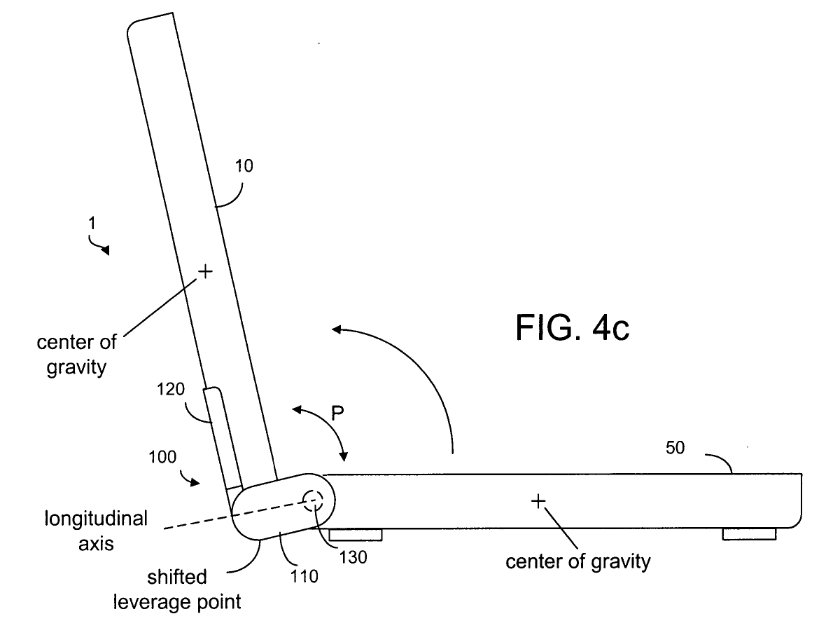

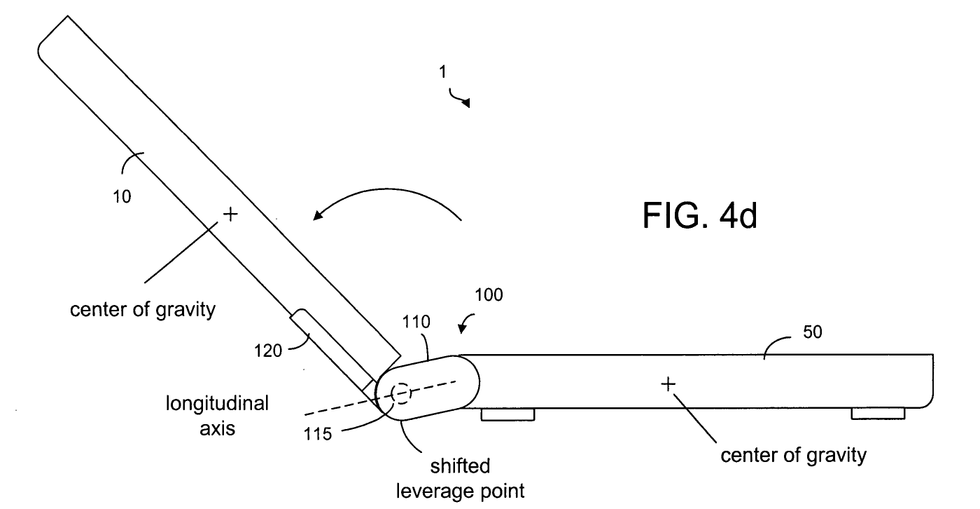

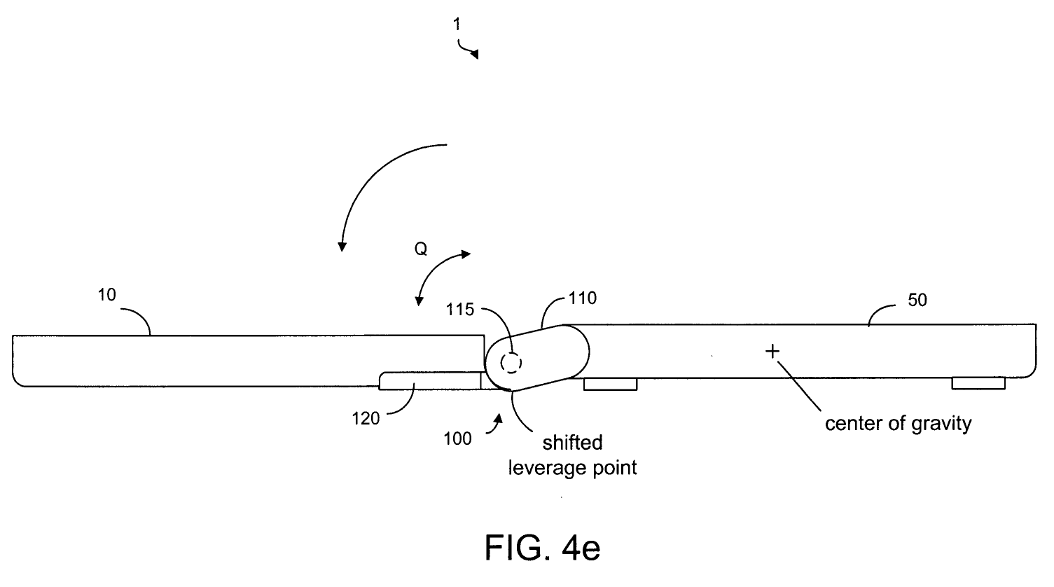

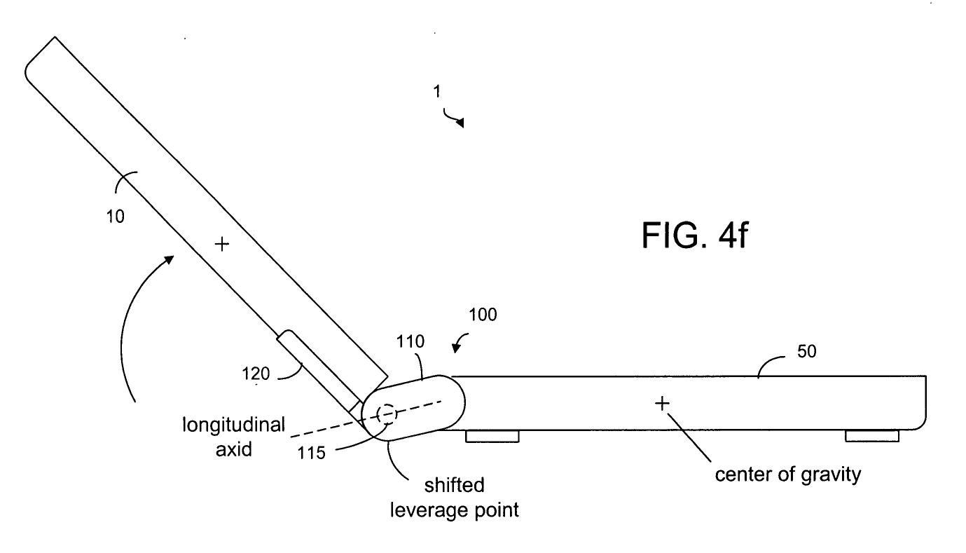

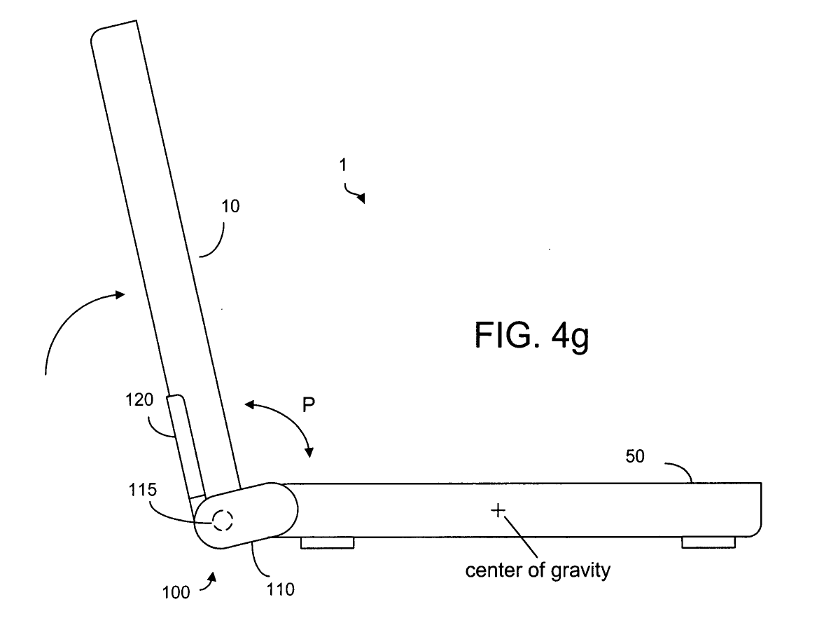

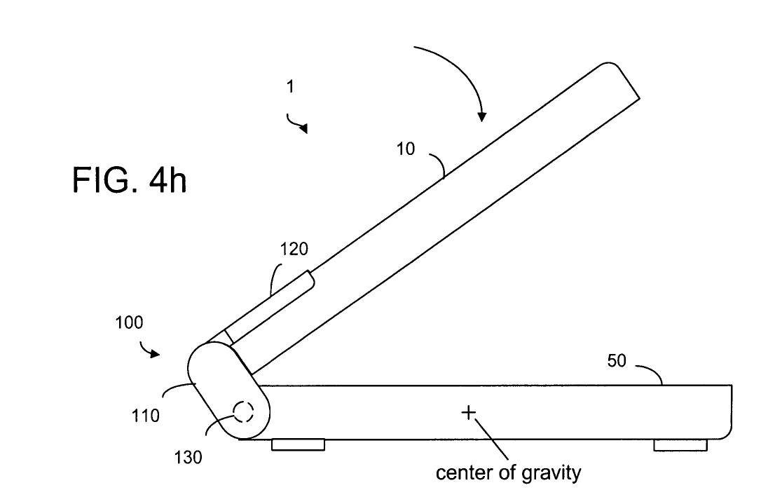

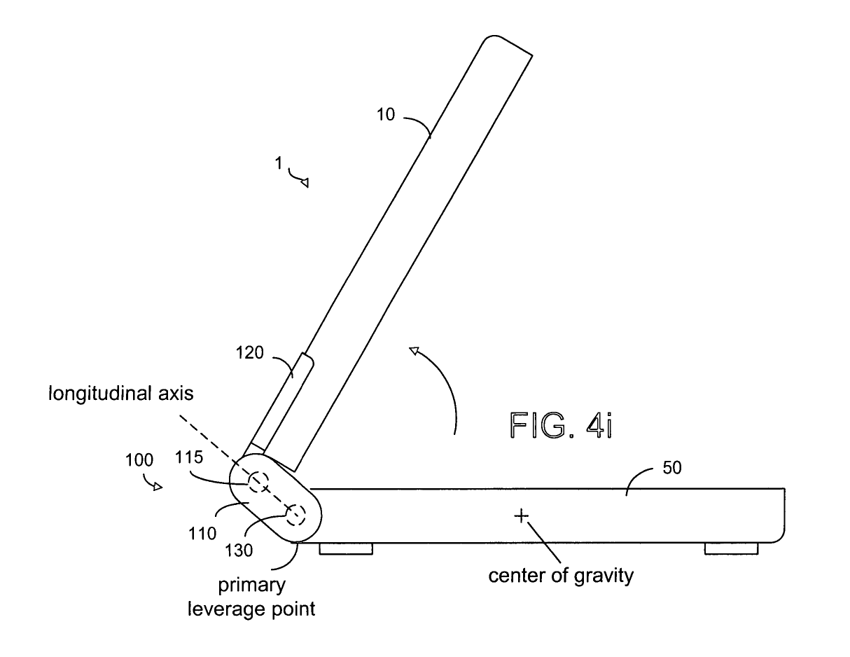

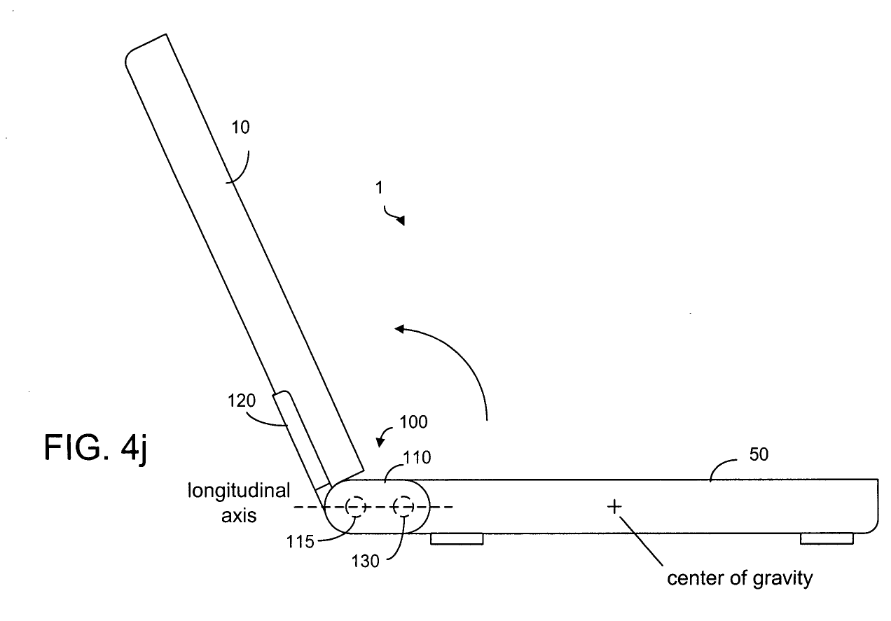

The hinge, according to the present invention, has two rotational axes. One rotational axis is defined by a shaft connected between two hinge arms. Each hinge arm has a pivot for rotatably mounting a bracket. The pivot on each hinge arm defines another rotation axis. As shown in FIG. 1, the hinge 100 has two hinge arms 110. Each hinge arm has a first section, a second section and a first bracket 120 pivotably mounted at pivot 115 at the first section. The hinge 100 has a shaft 130 mounted between the second sections of the hinge arms 110. The hinge 100 also has two sleeves 134 on opposite ends of the shaft 130 for mounting two second brackets 140. The hinge 100 has two restraining collars 136 to limit the lateral movement of the sleeves 134 along the shaft 130. The hinge is intended for use in an electronic device having an upper part rotatably connected to a lower part (see FIGS. 4a-4j). The first brackets are used for mounting the upper part 10 of the electronic device. For example, each first bracket has two screw wells 122, 124 so that the upper part can be fixedly mounted on the first brackets by screws or the like. The second brackets are used for fixedly mounting the lower part of the electronic device so as to allow the hinge arms 110 to rotate against the lower part about the shaft 130. As shown in FIG. 1, a number of electronic connectors 200 and electronic cables 210 are used to convey electronic signals between the upper and lower parts of the electronic device. The electronic connectors and cables are known in the art and are not part of the present invention.

The hinge 100, according to the present invention, has a primary leverage point which is located near the shaft 130 when the hinge arms 110 are oriented near a vertical position. When the electronic device is placed horizontally on a surface (not shown) in a closed position, the first brackets 120 are substantially parallel to the surface and the bottom of the lower part of the electronic device (see FIG. 4a).

When a user opens the device, the first brackets 120 and the hinge arms 110 are rotated about the shaft 130 against the lower part, while the upper part is kept stationary relative to the hinge arms 110 (see FIG. 4b). The upper part can be rotated about the shaft 130 until the upper or first section of each hinge arm 110 is in contact with the surface. At this position, the leverage point of the device has moved from the second section of the hinge arms 110 to the first section. The shifted leverage point is located substantially below the pivot 115 of the hinge arms 110.

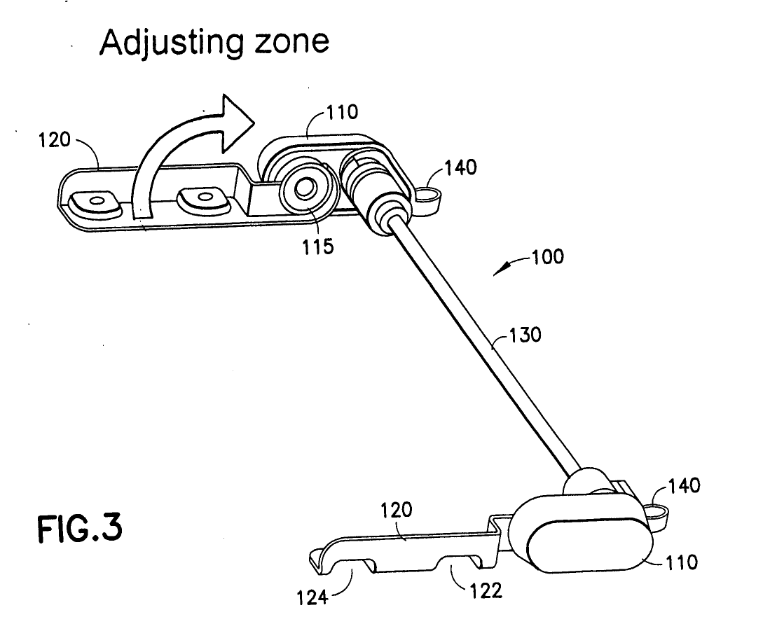

After the first section of the hinge arms 110 is in contact with the surface, the first brackets 120 can be rotated against the hinge arms 110 about the pivots 115 so as to increase the angle between the upper part and the lower part of the electronic device (see FIGS. 4d and 4e). As shown in FIG. 3, the first brackets 120 is rotated against the hinge arms 110 so that the angle between the first and lower parts of the electronic device can be adjusted within an adjusting zone.

FIGS. 4a to 4h illustrate an electronic device having an upper part rotatably linked to a lower part for opening and closing. As shown, the electronic device 1 has an upper part 10 and a lower part 50. If the electronic device 1 is a laptop computer, for example, the upper part 10 usually has a display panel and the lower part 50 is an engine part containing the motherboard and the keyboard. It is generally desirable that the weight of the entire laptop computer be reduced while increasing the size of the display panel. As a result, the upper part becomes heavy as compared to the lower part. When the angle between the upper part and the lower part is large, say between 120 and 180 degrees, the laptop computer becomes less stable. The hinge 100, according to the present invention, moves the leverage point away from the center of gravity of the lower part, effectively increasing the moment of the lower part in countering the center of gravity of the upper part. As such, the electronic device becomes more stable when it is in the open position.

FIG. 4a shows the device 1 in a closed position. As shown, the first brackets 120 are substantially parallel to the bottom of the lower part 50, and the leverage point is located substantially along the longitudinal axis of the hinge arms 110. At this position, the longitudinal axis of the hinge arms 110 is substantially perpendicular to the upper part 10 of the electronic device.

As shown in FIG. 4b, when the device 1 is opened, the upper part 10 is rotated together with the hinge arms 110 against the lower part 50 about the rotational axis as defined by the shaft 130. The longitudinal axis is still perpendicular to the upper part 10. FIG. 4c shows the opening of the device 1 until the angle between the upper part 10 and the lower part 50 is equal an angle P. It is preferred that the angle P is about 105 degrees. However, P can be smaller or greater than 105 degrees. For example, P can be equal to or smaller than 90 degrees. At this point, the upper or first section of the hinge arms 110 is in contact with the surface and the leverage point of the device 1 has shifted outward, further away from the center gravity of the lower part 50. However, before the angle between the upper part 10 and the lower part 50 reaches the angle P, the first section of the hinge arms is spaced from the surface and the leverage point of the hinge is near the shaft 130. As shown in FIGS. 4b and 4c, while the upper part 10 is rotated against the lower part 50 about the shaft 130, the upper part is kept stationary relative to the hinge arms 110. Thus, the angle between the hinge arms 110 and the upper part 10 does not change.

If the user wishes to increase the angle between the upper part 10 and the lower part 50, the user can further rotate the upper part 10 against the hinge arms 110 about the pivot 115, as shown in FIGS. 4d and 4e. FIG. 4e shows the opening of the device 1 wherein the angle between the upper part 10 and the lower part 50 is substantially equal to 180 degrees.

If the angle between the upper part and the lower part is greater than 90 degrees, (see FIGS. 4c and 4d, for example) the center of gravity of the upper part and the center of gravity of the lower part are located on different sides of the hinge 110. Because the distance between the leverage point and the center of gravity of the lower part is increased by a length which is approximately equal to the distance between the two rotational axes, the electronic device becomes more stable.

When the user closes the electronic device 1 or adjusts the angle between the upper part 10 and the lower part 50, it is preferred that the upper part 10 is rotated against the hinge arms 110 while the lower part 50 is kept stationary relative to the hinge arms 110 as shown in FIGS. 4f and 4g. After the angle between the upper part 10 and the hinge arms reaches the angle P (see FIG. 4g), the upper part 10 is rotated against the lower part about the shaft 130, as shown in FIG. 4h. The rotation about the shaft 130 can be carried out further until the electronic device is in the closed position (see FIG. 4a).

In the embodiment as described in conjunction with FIGS. 4a to 4h, only one of the rotational axes is used for the opening and closing of the device 1. As shown in FIGS. 4b and 4c, only the rotational axis defined by the shaft 130 is used to change the angle between the upper part 10 and the lower part 50. The upper part is stationary relative to the hinge arms until the longitudinal axis is substantially parallel to the lower part. Thus, the angle between the upper part 10 and hinge arms 110 remains the same while the hinge arms are rotated against the lower part about shaft 130.

In a different embodiment, the angle between the upper part and the hinge arms is increased as the hinge arms are rotated against the lower part. Thus, both the first and second rotational axes are used when the user opens the device.

As shown in FIG. 4i, both the pivot 115 on the hinge arms 110 and the shaft 130 are used for rotation when the upper part 10 is rotated against the lower part 50. As such, the angle between the upper part 10 and the hinge arms 110 is increased while the user opens the device. When the longitudinal of the hinge arms 110 is parallel to the surface, as shown in FIG. 4j, the angle between the upper part 10 and the lower part 50 is much larger than 90 degrees, for example. If the user wishes to increase the angle, the user further rotates the upper part 10 against the lower part 50 until the first section of the hinge arm is in contact with the surface. After that, the upper part 10 is rotated against the hinge arm 110 at the pivot point 115 while keeping the hinge arms 110 stationary relative to the lower part 50. It is understood that when the user closes the device 1, both rotational axes are used to allow the upper part 10 to rotate against the lower part 50.

In sum, the present invention provides a hinge for use in an electronic device of a clamshell type design in that the device has an upper part pivotably connected to a lower part via the hinge. The hinge comprises

at least two hinge arms, each hinge arm having a first end and an opposing second end;

a first mounting member for pivotably mounting the second device part to the hinge arms on the first end at a first rotational axis for changing the angle between the first and the second device parts by rotating the second device part against the hinge arms about the first rotation axis when the angle between the first and second device parts is within the first angular range; and

a second mounting member for pivotably mounting the first device part to the hinge arms on the second end at a second rotation axis for changing the angle between the first and the second device parts by rotating the first device part against the hinge arms about the second rotation axis when the angle between the first and second device parts is within the second angular range beyond the first angular range.

When the device is placed on a surface and the angle between the first and second device parts is within the first angular range, the first end of hinge arms provides a leverage point. When the angle is within the second angular range, the second end of the hinge arms is also in contact with the surface for providing a different leverage point further away from the center of gravity of the second device part. The first angular range is between 0 degree to 105 degrees and the second angular range is between 105 degrees to 180 degrees, for example. However, the first and second ranges can be designed differently in that the angle P can be smaller or larger than 105 degrees. For example, the angle P can be smaller than 90 degrees, but can also be larger than 105 degrees. Furthermore, when the device is in the closed position, the angle between the longitudinal axis of the hinge arms and the surface can be greater or smaller than 90 degrees.

In one embodiment of the present invention, only the first rotational axis is used for rotation when the angle is within the first angular range. In another embodiment of the present invention, both the first and second rotational axes are used for rotation when the angle is within the first angular range. In both embodiments, only the second rotational axis is used for rotation when the angle is within the second angular range.

Using a hinge with two independent rotational axes for rotating the upper device part in relation to the lower device part, the present invention effectively moves the leverage point on the hinge away from the center of gravity of lower part of the device. Because the distance between the center of gravity of the lower part and the leverage point increases, the device is more stable regarding the countering of the center of gravity of the lower part of the device against the center of gravity of the upper part.

The hinge, according to the present invention, can be used on an electronic device such as a PDA, a laptop or notebook computer, a mobile television set, a mobile phone, a gaming console or the like.

Thus, although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method to improve stability of an electronic device, the electronic device having a first device part and a second device part rotatably connected to the first device part via a hinge, the hinge having a leverage point at a first position and a second position, each of the first and second device parts having a center of gravity, the device operable in a closed position and in an open position, wherein when the device is operated in an open position, the first device part and the second device part form an angle having at least a first angular range and a second angular range beyond the first angular range, said method comprising:
positioning the leverage point at the first position when the angle is within the first angular range; and
shifting the leverage point to the second position further away from the center of gravity of the second device part when the angle is within the second angular range so as to increase the distance between the leverage point and the center of gravity of the second device part.

2. The method of claim 1, said method further comprising:
providing a first rotation axis on the hinge for changing the angle between the first and the second device parts by rotating the first device part relative to the second device part about the first rotation axis when the angle between the first and second device parts is within the first angular range; and
providing a second rotation axis on the hinge for changing the angle between the first and the second device parts by rotating the first device part relative to the second device part about the second rotation axis when the angle between the first and second device part is within the second angular range.

3. The method of claim 2, further comprising:
providing a shaft at the first rotation axis for pivotably mounting the second device part to the hinge so as to allow the first device part to rotate relative to the second device part when the angle is within the first angular range.

4. The method of claim 3, comprising:
providing two hinge arms on the hinge, each arm having
a first end for mounting the shaft, and
an opposing second end for pivotably mounting the first device part at the second rotation axis so as to allow the first device part to rotate against the hinge arms when the angle is within the second angular range.

5. The method of claim 2, wherein the second rotation axis is also used for rotation when the angle between the first and second device parts is within the first angular range.

6. The method of claim 1, wherein when the angle is within the second angular range, the center of gravity of the first device part and the center of gravity of the second device parts are located on the different sides of the hinge.

7. The method of claim 6, wherein when the center of gravity of the first device part and the center of gravity of the second device parts are located on the same side of the hinge, the angle is within the first angular range.

8. A hinge for use in an electronic device having a first device part rotatably mounted to a second device part, each of the first and second device parts having a center of gravity, the device operable in a closed position and in an open position, wherein when the device is operated in the open position, the first device part and the second device part form an angle having at least a first angular range and a second angular range beyond the first angular range, said hinge comprising:
at least two hinge arms, each hinge arm having a first end and an opposing second end;
a first mounting member for pivotably mounting the second device part to the hinge arms on the first end at a first rotational axis for changing the angle between the first and the second device parts by rotating the second device part against the hinge arms about the first rotation axis when the angle between the first and second device parts is within the first angular range; and
a second mounting member for pivotably mounting the first device part to the hinge arms on the second end at a second rotation axis for changing the angle between the first and the second device parts by rotating the first device part against the hinge arms about the second rotation axis when the angle between the first and second device parts is within the second angular range beyond the first angular range.

9. The hinge of claim 8, wherein the device is placed on a surface and the angle is within the first angular range, the second end of the hinge arms is spaced from the surface.

10. The hinge of claim 9, when the angle is within the second angular range, the second end of the hinge arms is in contact with the surface for providing a leverage point further away from the center of gravity of the second device part.

11. The hinge of claim 8, wherein the first mounting member comprises a shaft and one or more brackets for rotatably mounting the second device part relative to the hinge arms.

12. The hinge of claim 8, wherein the second mounting member comprises one or more brackets for rotatably mounting the first device part relative to the hinge arms.

13. The hinge of claim 8, wherein when the angle is within the first angular range, the second rotational axis is also used for rotation in order to change the angle between the first and the second device parts.

14. The hinge of claim 8, wherein when the angle is within the second angular range, the center of gravity of the second device part and the center gravity of the first device part are located on different sides of the hinge arms.

15. The hinge of claim 14, wherein when the center of gravity of the first device part and the center of gravity of the second device part are located on the same side of the hinge arms, the angle is within the first angular range.

16. An electronic device comprising:
a hinge;
a first device part; and
a second device part rotatably mounted to the first device part via the hinge, each of the first and second device parts having a center of gravity, the device operable in a closed position and in an open position, wherein when the device is operated in the open position, the first device part and the second device part form an angle having at least a first angular range and a second angular range beyond the first angular range, said hinge comprising:
at least two hinge arms, each hinge arm having a first end and an opposing second end;
a first mounting member for pivotably mounting the second device part to the hinge arms on the first end at a first rotational axis for changing the angle between the first and the second device parts by rotating the second device part against the hinge arms about the first rotation axis when the angle between the first and second device parts is within the first angular range; and
a second mounting member for pivotably mounting the first device part to the hinge arms on the second end at a second rotation axis for changing the angle between the first and the second device parts by rotating the first device part against the hinge arms about the second rotation axis when the angle between the first and second device parts is within the second angular range beyond the first angular range.

17. The electronic device of claim 16, wherein the first mounting member comprises a shaft and one or more brackets for rotatably mounting the second device part relative to the hinge arms.

18. The electronic device of claim 16, wherein the second member comprises one or more brackets for rotatably mounting the first device part relative to the hinge arms.

19. The electronic device of claim 16, wherein when the second device part is placed in contact with a surface and the angle is within the second angular range, the second end of the hinge arms is in contact with the surface for providing a leverage point for the device.

20. The electronic device of claim 16, wherein when the angle is within the first angular range, the second rotational axis is also used for rotation in order to change the angle between the first and the second device parts.

21. The electronic device of claim 16, comprising a mobile phone.

22. The electronic device of claim 16, comprising a mobile television set.

23. The electronic device of claim 16, comprising a personal digital assistant device.

24. The electronic device of claim 16, comprising a laptop computer.
